(19) United States
(12) Patent Application Publication
(10) Pub. No.: US 2026/0120643 A1
(43) Pub. Date: Apr. 30, 2026

(54) DISPLAY DEVICE, METHOD OF OPERATING A DISPLAY DEVICE, AND ELECTRONIC DEVICE

(71) Applicant: Samsung Display Co., Ltd., Yongin-Si (KR)

(72) Inventors: TAE-SEOK HA, Yongin-si (KR); JONGWOON KIM, Yongin-si (KR)

(21) Appl. No.: 19/278,775

(22) Filed: Jul. 24, 2025

(30) Foreign Application Priority Data
Oct. 29, 2024 (KR) 10-2024-0149659

(51) Int. Cl. G09G 3/3258; G09G 3/32

(52) U.S. Cl. CPC G09G 3/3258; G09G 3/32; G09G 2310/027; G09G 2310/066; G09G 2320/0626; G09G 2320/0673; G09G 2330/021

(57) ABSTRACT

A display device includes a display panel including a plurality of pixels, and a panel driver configured to receive image data and a display brightness value, and to drive the display panel based on the image data and the display brightness value. The panel driver determines whether the image data represent a low gray image, performs a smooth dimming operation that gradually changes a luminance of the display panel to a luminance corresponding to the display brightness value over a plurality of frame periods in a first case where the image data do not represent the low gray image, and does not perform the smooth dimming operation in a second case where the image data represent the low gray image.

### CROSS-REFERENCE TO RELATED APPLICATION(S)

This application claims priority under 35 USC § 119 to Korean Patent Application No. 10-2024-0149659, filed on Oct. 29, 2024 in the Korean Intellectual Property Office (KIPO), the content of which is herein incorporated by reference in its entirety.

### BACKGROUND

### 1. Field

The present inventive concept relates to a display device, and more particularly to a display device performing a dimming operation, a method of operating the display device, and an electronic device including the display device.

### 2. Description of the Related Art

A display device may include a display panel that includes a plurality of pixels, and a panel driver that drives the display panel. The panel driver may include a scan driver that provides scan signals to the plurality of pixels, a gamma voltage generator that generates gamma voltages, a data driver that provides data voltages to the plurality of pixels based on the gamma voltages, and a controller that controls the scan driver, the gamma voltage generator and the data driver.

The panel driver may receive a display brightness value (“DBV”) from an external processor, and may perform a dimming operation that changes a luminance of the display panel to a luminance corresponding to the display brightness value by adjusting the gamma voltages according to the display brightness value.

### SUMMARY

Some embodiments provide a display device capable of preventing a luminance change caused by a smooth dimming operation from being perceived when a normal image is displayed after a low gray image is displayed.

Some embodiments provide a method of operating a display device capable of preventing a luminance change caused by a smooth dimming operation from being perceived when a normal image is displayed after a low gray image is displayed.

Some embodiments provide an electronic device including a display device capable of preventing a luminance change caused by a smooth dimming operation from being perceived when a normal image is displayed after a low gray image is displayed.

According to embodiments, there is provided a display device including a display panel including a plurality of pixels, and a panel driver configured to receive image data and a display brightness value, and to drive the display panel based on the image data and the display brightness value. The panel driver is further configured to determine whether the image data represent a low gray image, to perform a smooth dimming operation that gradually changes a luminance of the display panel to a luminance corresponding to the display brightness value over a plurality of frame periods in a first case where the image data do not represent the low gray image, and not to perform the smooth dimming operation in a second case where the image data represent the low gray image.

In embodiments, in the second case, the panel driver may change the luminance of the display panel to the luminance corresponding to the display brightness value in a frame period in which the display brightness value is received.

In embodiments, in the first case, to perform the smooth dimming operation, the panel driver may gradually change gamma voltages over the plurality of frame periods. In the second case, the panel driver may change the gamma voltages in a frame period in which the display brightness value is received.

In embodiments, the low gray image may be an image lower than or equal to a reference gray level.

In embodiments, the reference gray level may have a fixed value.

In embodiments, the reference gray level may be settable by a gray option.

In embodiments, the panel driver may count a number of pixels for which the image data indicate a gray level lower than or equal to a reference gray level among the plurality of pixels, may compare the counted number of the pixels with a reference number, may determine that the counted number of the pixels is greater than or equal to the reference number, and may determine that the image data represent the low gray image.

In embodiments, the reference gray level and the reference number may have fixed values.

In embodiments, the reference gray level may be settable by a gray option, and the reference number may be settable by a number option.

In embodiments, the panel driver may include a scan driver configured to provide scan signals to the plurality of pixels, a gamma voltage generator configured to generate gamma voltages, a data driver configured to provide data voltages to the plurality of pixels based on the gamma voltages, and a controller configured to control the scan driver, the gamma voltage generator and the data driver. The controller may include a low gray image determining block configured to determine whether the image data represent the low gray image, and a dimming block configured to control the gamma voltage generator to adjust the gamma voltages according to the display brightness value, and to selectively perform the smooth dimming operation according to whether the image data represent the low gray image.

In embodiments, the low gray image determining block may count a number of pixels for which the image data indicate a gray level lower than or equal to a reference gray level among the plurality of pixels, may compare the counted number of the pixels with a reference number, may determine that the counted number of the pixels is greater than or equal to the reference number, and may determine that the image data represent the low gray image.

In embodiments, the reference gray level may be a 0-gray level or a 1-gray level, and the reference number may be a total number of the plurality of pixels.

In embodiments, the controller may further include an option storing block configured to store a gray option and a number option. The low gray image determining block may count a number of pixels for which the image data indicate a gray level lower than or equal to a reference gray level indicated by the gray option among the plurality of pixels, may compare the counted number of the pixels with a reference number indicated by the number option, may determine that the counted number of the pixels is greater than or equal to the reference number, and may determine that the image data represent the low gray image.

In embodiments, in the first case where the low gray image determining block determines that the image data do not represent the low gray image, the dimming block may control the gamma voltage generator to gradually change the gamma voltages over the plurality of frame periods. In the second case where the low gray image determining block determines that the image data represent the low gray image, the dimming block may control the gamma voltage generator to change the gamma voltages in a frame period in which the display brightness value is received.

According to embodiments, there is provided a method of operating a display device. In the method, image data and a display brightness value are received, it is determined whether the image data represent a low gray image, a smooth dimming operation that gradually changes a luminance of the display panel to a luminance corresponding to the display brightness value over a plurality of frame periods is performed in a first case where the image data do not represent the low gray image, and the luminance of the display panel is changed to the luminance corresponding to the display brightness value without performing the smooth dimming operation in a second case where the image data represent the low gray image.

In embodiments, to perform the smooth dimming operation, gamma voltages may be gradually changed over the plurality of frame periods.

In embodiments, to determine whether the image data represent the low gray image, a number of pixels for which the image data indicate a gray level lower than or equal to a reference gray level may be counted among the plurality of pixels, the counted number of the pixels may be compared with a reference number, it may be determined that the counted number of the pixels is greater than or equal to the reference number, and it may be determined that the image data represent the low gray image.

In embodiments, the reference gray level and the reference number may have fixed values.

In embodiments, the reference gray level may be settable by a gray option, and the reference number may be settable by a number option.

According to embodiments, there is provided an electronic device including a processor configured to provide image data and a display brightness value, a display panel including a plurality of pixels, and a panel driver configured to receive the image data and the display brightness value, and to drive the display panel based on the image data and the display brightness value. The panel driver determines whether the image data represent a low gray image, performs a smooth dimming operation that gradually changes a luminance of the display panel to a luminance corresponding to the display brightness value over a plurality of frame periods in a first case where the image data do not represent the low gray image, and does not perform the smooth dimming operation in a second case where the image data represent the low gray image.

As described above, in a display device, a method of operating the display device, and an electronic device including the display device according to embodiments, a smooth dimming operation that gradually changes a luminance of a display panel to a luminance corresponding to a display brightness value over a plurality of frame periods may be performed in a first case where image data do not represent a low gray image (e.g., a black image), and the smooth dimming operation may not be performed in a second case where the image data represent the low gray image. Accordingly, when a normal image is displayed after the low gray image is displayed, or when a mode of the display device is switched, a luminance change caused by the smooth dimming operation may be prevented from being perceived.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments.

FIG. 2 is a diagram illustrating examples of luminances of a display panel according to a gray level at a plurality of display brightness values.

FIG. 3 is a diagram for describing an example of a smooth dimming operation performed in a display device according to embodiments.

FIGS. 4A and 4B are diagrams for describing examples of luminance changes caused by a smooth dimming operation in cases where the smooth dimming operation is performed when a mode of a display device is switched.

FIG. 5 is a block diagram illustrating an example of a controller included in a display device according to embodiments.

FIG. 6 is a diagram for describing an example in which a luminance change caused by a smooth dimming operation does not occur when a mode of a display device is switched according to embodiments.

FIG. 7 is a flowchart illustrating a method of operating a display device according to embodiments.

FIG. 8 is a diagram for describing an example in which it is determined whether image data represent a low gray image.

FIG. 9 is a flowchart illustrating a method of operating a display device according to embodiments.

FIG. 10A is a diagram illustrating an example of dithered black image data, and FIGS. 10B and 10C are diagrams for describing examples in which it is determined whether image data represent a low gray image.

FIG. 11 is a flowchart illustrating a method of operating a display device according to embodiments.

FIG. 12 is a diagram for describing examples in which it is determined whether image data represent a low gray image.

FIG. 13 is a flowchart illustrating a method of operating a display device according to embodiments.

FIG. 14 is a diagram for describing examples in which it is determined whether image data represent a low gray image.

FIG. 15 is a block diagram illustrating an electronic device including a display device according to embodiments.

FIG. 16 is a block diagram illustrating an example of an electronic device according to embodiments.

### DETAILED DESCRIPTION OF THE EMBODIMENTS

The embodiments are described more fully hereinafter with reference to the accompanying drawings. Like or similar reference numerals refer to like or similar elements throughout.

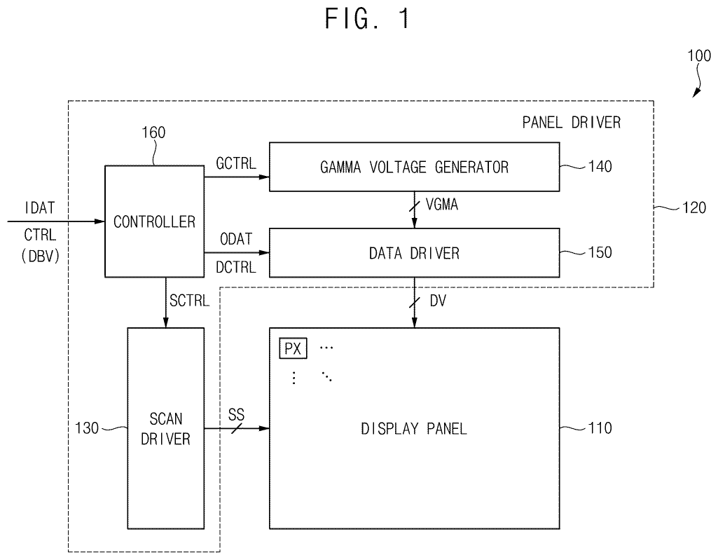

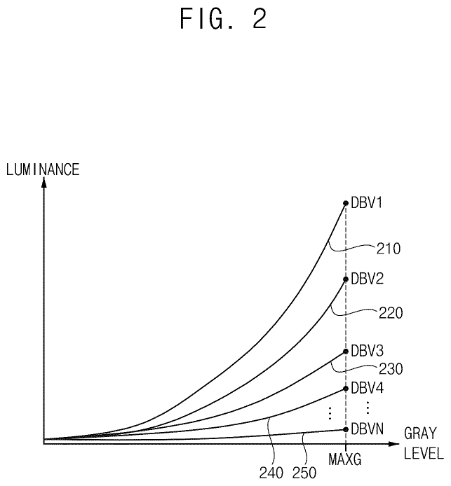

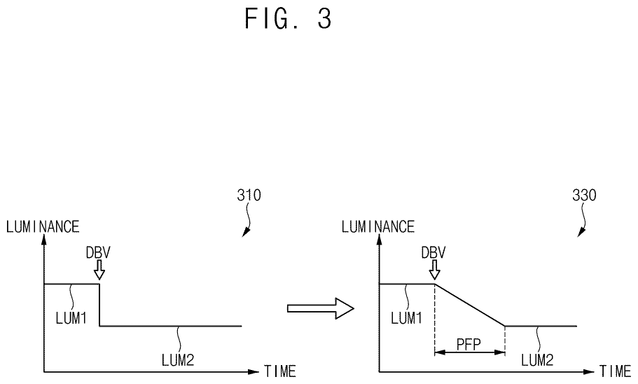

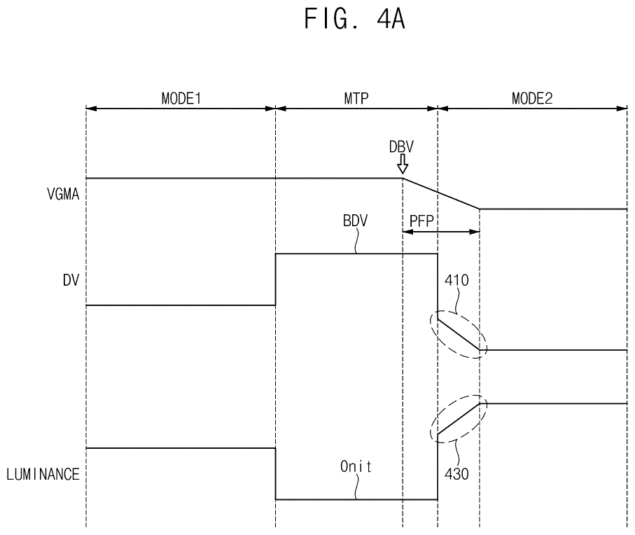

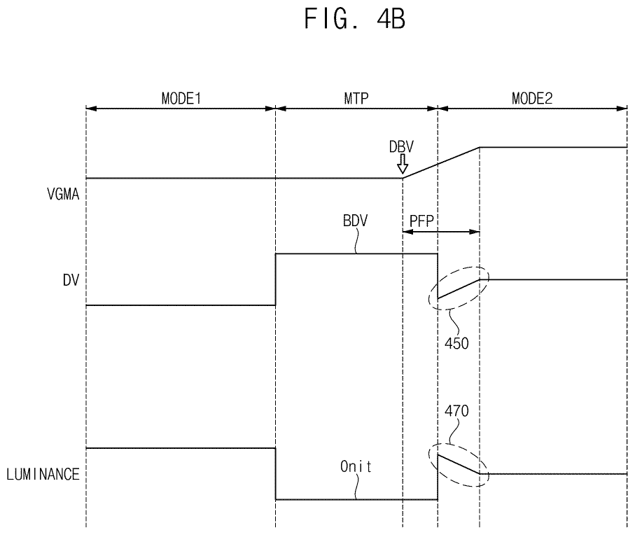

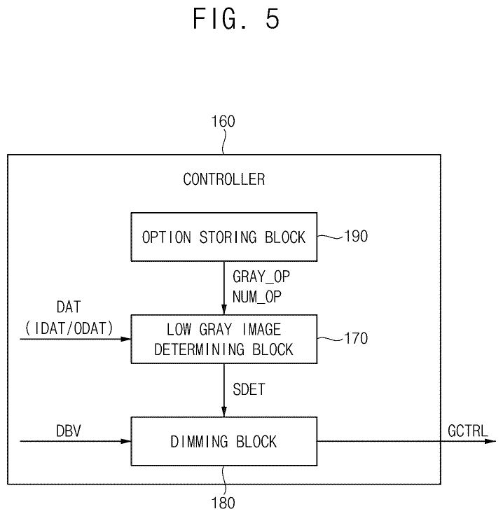

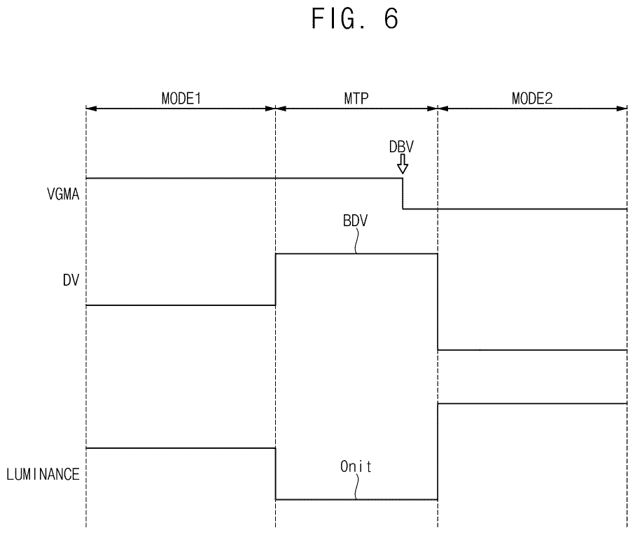

FIG. 1 is a block diagram illustrating a display device 100 according to embodiments, FIG. 2 is a diagram illustrating examples of luminances of a display panel according to a gray level at a plurality of display brightness values, FIG. 3 is a diagram for describing an example of a smooth dimming operation performed in a display device according to embodiments, FIGS. 4A and 4B are diagrams for describing examples of luminance changes caused by a smooth dimming operation in cases where the smooth dimming operation is performed when a mode of a display device is switched, FIG. 5 is a block diagram illustrating an example of a controller 160 included in a display device according to embodiments, and FIG. 6 is a diagram for describing an example in which a luminance change caused by a smooth dimming operation does not occur when a mode of a display device is switched according to embodiments.

Referring to FIG. 1, the display device 100 according to embodiments may include a display panel 110 that includes a plurality of pixels PX, and a panel driver 120 that drives the display panel 110. In some embodiments, the panel driver 120 may include a scan driver 130 that provides scan signals SS to the plurality of pixels PX, a gamma voltage generator 140 that generates gamma voltages VGMA, a data driver 150 that provides data voltages DV to the plurality of pixels PX based on the gamma voltages VGMA, and a controller 160 that controls the scan driver 130, the gamma voltage generator 140 and the data driver 150.

The display panel 110 may include a plurality of data lines, a plurality of scan lines, and a plurality of pixels PX connected to the plurality of data lines and the plurality of scan lines. In some embodiments, each pixel PX may include a light emitting element, and the display panel 110 may be a light emitting display panel. For example, the light emitting element may be an organic light emitting diode (“OLED”), and the display panel 110 may be an OLED display panel. In other examples, the light emitting element may be a nano light emitting diode (“NED”), a quantum dot (“QD”) light emitting diode, a micro light emitting diode, an inorganic light emitting diode, or any other suitable light emitting element. However, the display panel 110 is not limited to the light emitting display panel, and may be any suitable display panel.

The scan driver 130 may generate the scan signals SS based on a scan control signal SCTRL received from the controller 160, and may sequentially provide the scan signals SS to the plurality of pixels PX on a row-by-row basis through the plurality of scan lines. The scan control signal SCTRL may include, but is not limited to, a scan start signal and a scan clock signal. In some embodiments, the scan driver 130 may be integrated or formed in the display panel 110. In other embodiments, the scan driver 130 may be implemented with one or more integrated circuits. Further, although it is not illustrated in FIG. 1, the panel driver 120 may further include an emission driver that provides emission signals to the plurality of pixels PX. In some embodiments, the emission driver may be integrated or formed in the display panel 110.

The gamma voltage generator 140 may generate the gamma voltages VGMA at reference gray levels based on a gamma control signal GCTRL received from the controller 160, and may provide the gamma voltages VGMA to the data driver 150. For example, the gamma voltage generator 140 may include, but is not limited to, a resistor array that generates the gamma voltages VGMA by dividing a voltage between a gamma top voltage and a gamma bottom voltage, and amplifiers that output the gamma voltages VGMA. Further, the gamma voltage generator 140 may change voltage levels of the gamma voltages VGMA in response to the gamma control signal GCTRL.

The data driver 150 may receive output image data ODAT and a data control signal DCTRL from the controller 160, may receive the gamma voltages VGMA from the gamma voltage generator 140, may generate gray voltages respectively corresponding to a plurality of gray levels (e.g., 256 gray levels from a 0-gray level to a 255-gray level) based on the gamma voltages VGMA, and may provide the gray voltages corresponding to the output image data ODAT as the data voltages DV to the plurality of pixels PX through the plurality of data lines in response to the data control signal DCTRL. In some embodiments, the data control signal DCTRL may include, but is not limited to, an output data enable signal, a horizontal start signal and a load signal. In some embodiments, the data driver 150 and the controller 160 may be implemented as a single integrated circuit, and the single integrated circuit may be referred to as a timing controller embedded data driver (“TED”) integrated circuit. In other embodiments, the data driver 150 and the controller 160 may be implemented as separate integrated circuits.

The controller 160 (e.g., a timing controller) may receive input image data IDAT and a control signal CTRL from an external processor (e.g., an application processor (“AP”), a graphics processing unit (“GPU”) or a graphics card). The input image data IDAT may be, but is not limited to, RGB image data including red image data, green image data and blue image data. The control signal CTRL may include a display brightness value DBV indicating a luminance of the display panel 110. For example, the display brightness value DBV may indicate a desired maximum luminance of the display panel 110, or the luminance of the display panel 110 when the input image data IDAT indicate a maximum gray level (e.g., a 255-gray level). In some embodiments, the control signal CTRL may further include, but is not limited to, a vertical synchronization signal, a horizontal synchronization signal, an input data enable signal, a master clock signal, etc. The controller 160 may generate the output image data ODAT, the data control signal DCTRL and the scan control signal SCTRL based on the input image data IDAT and the control signal CTRL. The controller 160 may control an operation of the scan driver 130 by providing the scan control signal SCTRL to the scan driver 130, and may control an operation of the data driver 150 by providing the output image data ODAT and the data control signal DCTRL to the data driver 150.

In the display device 100 according to embodiments, the panel driver 120 may perform a dimming operation that changes the luminance of the display panel 110 according to the display brightness value DBV. In some embodiments, the panel driver 120 may adjust the gamma voltages VGMA to perform the dimming operation. For example, as illustrated in FIG. 2, the panel driver 120 may adjust the gamma voltages VGMA such that the display panel 110 has a first luminance curve 210 according to the gray level when the panel driver 120 receives a first display brightness value DBV1 as a luminance at the maximum gray level MAXG (e.g., the 255-gray level), and may adjust the gamma voltages VGMA such that the display panel 110 has a second luminance curve 220 lower than the first luminance curve 210 when the panel driver 120 receives a second display brightness value DBV2 lower than the first display brightness value DBV1 as the luminance at the maximum gray level MAXG. Further, when the panel driver 120 receives a third display brightness value DBV3, a fourth display brightness value DBV4 or an N-th display brightness value DBVN, where N is an integer greater than or equal to 2, the panel driver 120 may adjust the gamma voltages VGMA such that the display panel 110 has a third brightness curve 230, a fourth brightness curve 240 or an N-th brightness curve 250, respectively.

Further, in the display device 100 according to embodiments, the panel driver 120 may perform a smooth dimming operation that gradually changes the luminance of the display panel 110 to a luminance corresponding to the display brightness value DBV over a plurality of frame periods in order to prevent a rapid luminance change of the display panel 110 from being perceived when the display brightness value DBV is changed from a previous display brightness value. FIG. 3 illustrates examples of luminances 310 and 330 of the display panel 110 in cases where the input image data IDAT indicate an arbitrary constant gray level and the display brightness value DBV is decreased from a previous display brightness value. As illustrated in FIG. 3, in a case where the smooth dimming operation is not performed, the luminance 310 of the display panel 110 may be rapidly changed from a first luminance LUM1 corresponding to the previous display brightness value to a second luminance LUM2 corresponding to a newly received display brightness value DBV. However, in the display device 100 according to embodiments, the panel driver 120 may gradually change the luminance 330 of the display panel 110 from the first luminance LUM1 to the second luminance LUM2 over a plurality of frame periods PFP. In some embodiments, to gradually change the luminance 330 of the display panel 110 over the plurality of frame periods PFP, the panel driver 120 may gradually change the gamma voltages VGMA over the plurality of frame periods PFP. For example, in a case where each pixel PX includes a driving transistor that is a P-type metal-oxide-semiconductor (“PMOS”) transistor, the panel driver 120 may gradually increase the gamma voltages VGMA over the plurality of frame periods PFP to gradually decrease the luminance 330 of the display panel 110 from the first luminance LUM1 to the second luminance LUM2 over the plurality of frame periods PFP.

However, in a case where the display brightness value DBV is received and the smooth dimming operation that gradually changes the luminance of the display panel 110 over the plurality of frame periods PFP is performed in response to the display brightness value DBV while the display panel 110 displays a black image, an undesired luminance change caused by the smooth dimming operation may be perceived when a normal image is displayed after the black image is displayed.

For example, as illustrated in FIG. 4A, during a mode transition period MTP in which a mode of the display device 100 is switched from a first mode MODE1 to a second mode MODE2, the processor may provide the input image data IDAT representing the black image to the display device 100. For example, the mode transition period MTP may be, but is not limited to, a period between a high dynamic range (“HDR”) mode and a standard dynamic range (“SDR”) mode, a period in which a driving frequency of the display device 100 is changed, a period in which a resolution of the display device 100 is changed, or a period between a power-off mode (or a sleep mode) and a power-on mode. During the mode transition period MTP, the panel driver 120 may provide black data voltages BDV corresponding to a minimum gray level (e.g., a 0-gray level) as the data voltages DV to the display panel 110 based on the input image data IDAT representing the black image, and the display panel 110 may display the black image or an image having a luminance of about 0 nit based on the black data voltages BDV. Further, in the mode transition period MTP, the processor may provide the display device 100 with the display brightness value DBV that is increased from a previous display brightness value, and the panel driver 120 may perform the smooth dimming operation that gradually decreases the gamma voltages VGMA over the plurality of frame periods PFP in response to the display brightness value DBV. In a case where an image in the second mode MODE2 is displayed before the smooth dimming operation is completed, even if the processor provides the input image data IDAT indicating a constant gray level to the display device 100, the panel driver 120 may provide the display panel 110 with gradually decreasing data voltages 410 based on the gradually decreasing gamma voltages VGMA, and the display panel 110 may display an image having a gradually increasing luminance 430. That is, an undesired increase of the luminance 430 caused by the smooth dimming operation may be perceived.

In another example, as illustrated in FIG. 4B, in the mode transition period MTP, in a case where the processor provides the display brightness value DBV that is decreased from the previous display brightness value to the display device 100, the panel driver 120 may perform the smooth dimming operation that gradually increases the gamma voltages VGMA over the plurality of frame periods PFP in response to the display brightness value DBV. Further, in a case where an image in the second mode MODE2 is displayed before the smooth dimming operation is completed, even if the processor provides the input image data IDAT indicating a constant gray level to the display device 100, the panel driver 120 may provide the display panel 110 with gradually increasing data voltages 450 based on the gradually increasing gamma voltages VGMA, and the display panel 110 may display an image having a gradually decreasing luminance 470. That is, an undesired decrease of the luminance 470 caused by the smooth dimming operation may be perceived.

However, in the display device 100 according to embodiments, to prevent the undesired change of the luminance 430 and 470 caused by the smooth dimming operation, the panel driver 120 may determine whether the image data (e.g., the input image data IDAT or the output image data ODAT) represent a low gray image, and may selectively perform the smooth dimming operation depending on whether the image data represent the low gray image. In some embodiments, to selectively perform the smooth dimming operation, as illustrated in FIG. 5, the controller 160 of the panel driver 120 may include a low gray image determining block 170 and a dimming block 180.

The low gray image determining block 170 may determine whether the image data DAT represent the low gray image, and provide a determination result signal SDET to the dimming block 180. In some embodiments, the low gray image determining block 170 may determine whether the input image data IDAT received from the processor represent the low gray image. In other embodiments, the low gray image determining block 170 may determine whether the output image data ODAT provided to the data driver 150 represent the low gray image. Here, the low gray image may be an image corresponding to gray levels lower than or equal to a reference gray level, and may be, but is not limited to, an image of which the rapid change of the luminance (e.g., the luminance 310 illustrated in FIG. 3) caused by the dimming operation is not perceived.

In some embodiments, the low gray image may be an image lower than a reference gray level having a fixed value. For example, the low gray image may be, but is not limited to, a black image having a 0-gray level or a luminance of about 0 nit. The low gray image determining block 170 may count the number of pixels PX for which the image data DAT indicate a gray level lower than or equal to the reference gray level among the plurality of pixels PX, and may compare the counted number of the pixels PX with a reference number. In some embodiments, the reference gray level and the reference number may have fixed values. For example, the reference gray level may be, but is not limited to, a 0-gray level or a 1-gray level, and the reference number may be, but is not limited to, the total number of the plurality of pixels PX. Further, the low gray image determining block 170 may determine that the image data DAT do not represent the low gray image when the counted number of the pixels PX is less than the reference number, and may determine that the image data DAT represent the low gray image when the counted number of the pixels PX is greater than or equal to the reference number.

In other embodiments, the controller 160 may further include an option storing block 190 that stores a gray option GRAY_OP for setting a reference gray level and/or a number option NUM_OP for setting a reference number, and the low gray image may be an image lower than the reference gray level indicated by the gray option GRAY_OP. The low gray image determining block 170 may count the number of pixels PX for which the image data DAT indicate a gray level lower than or equal to the reference gray level indicated by the gray option GRAY_OP among the plurality of pixels PX, and may compare the counted number of the pixels PX with the reference number indicated by the number option NUM_OP. Further, the low gray image determining block 170 may determine that the image data DAT do not represent the low gray image if the counted number of the pixels PX is less than the reference number, and may determine that the image data DAT represent the low gray image if the counted number of the pixels PX is greater than or equal to the reference number.

The dimming block 180 may control the gamma voltage generator 140 to adjust the gamma voltages VGMA according to the display brightness value DBV. For example, in a case where the display brightness value DBV is increased from the previous display brightness value, the dimming block 180 may generate the gamma control signal GCTRL to decrease voltage levels of the gamma voltages VGMA, and the gamma voltage generator 140 may decrease the voltage levels of the gamma voltages VGMA in response to the gamma control signal GCTRL. In another example, in a case where the display brightness value DBV is decreased from the previous display brightness value, the dimming block 180 may generate the gamma control signal GCTRL to increase the voltage levels of the gamma voltages VGMA, and the gamma voltage generator 140 may increase the voltage levels of the gamma voltages VGMA in response to the gamma control signal GCTRL.

Further, the dimming block 180 may selectively perform the smooth dimming operation depending on whether the image data DAT represent the low gray image. For example, in a case where the determination result signal SDET indicates that the image data DAT do not represent the low gray image, to perform the smooth dimming operation, the dimming block 180 may control the gamma voltage generator 140 to gradually change the gamma voltages VGMA over the plurality of frame periods PFP. In this case, based on the gamma voltages VGMA that are gradually changed over the plurality of frame periods PFP, the luminance of the display panel 110 may be gradually changed to the luminance corresponding to the display brightness value DBV over the plurality of frame periods PFP. In an embodiment, in a case where the determination result signal SDET indicates that the image data DAT represent the low gray image, the dimming block 180 may not perform the smooth dimming operation, and may control the gamma voltage generator 140 to change the gamma voltages VGMA in a frame period in which the display brightness value DBV is received. In this case, the luminance of the display panel 110 may be changed to the luminance corresponding to the display brightness value DBV in the frame period in which the display brightness value DBV is received.

For example, as illustrated in FIG. 6, during the mode transition period MTP in which the mode of the display device 100 is switched from the first mode MODE1 to the second mode MODE2, in a case where the processor provides the input image data IDAT representing the black image to the display device 100, the low gray image determining block 170 may determine that the image data DAT (e.g., the input image data IDAT or the output image data ODAT) represent the low gray image. Further, even if the display brightness value DBV that is changed from a previous display brightness value is received during the mode transition period MTP, the dimming block 180 may not perform the smooth dimming operation, and may change the gamma voltages VGMA in the frame period in which the display brightness value DBV is received. Accordingly, unlike the examples of FIGS. 4A and 4B in which the undesired change of the luminance 430 and 470 is perceived in a period in which the smooth dimming operation is performed and the image in the second mode MODE2 is displayed, the display panel 110 may display the image with a desired luminance in the second mode MODE2.

As described above, in the display device 100 according to embodiments, in the case where the image data DAT do not represent the low gray image (e.g., the black image), the smooth dimming operation that gradually changes the luminance of the display panel 110 to the luminance corresponding to the display brightness value DBV over the plurality of frame periods PFP may be performed. Further, in the case where the image data DAT represent the low gray image, the smooth dimming operation may not be performed. Accordingly, in the display device 100 according to embodiments, when a normal image is displayed after the low gray image is displayed, or when the mode of the display device 100 is switched, the undesired change of the luminance 430 and 470 caused by the smooth dimming operation may be prevented from being perceived.

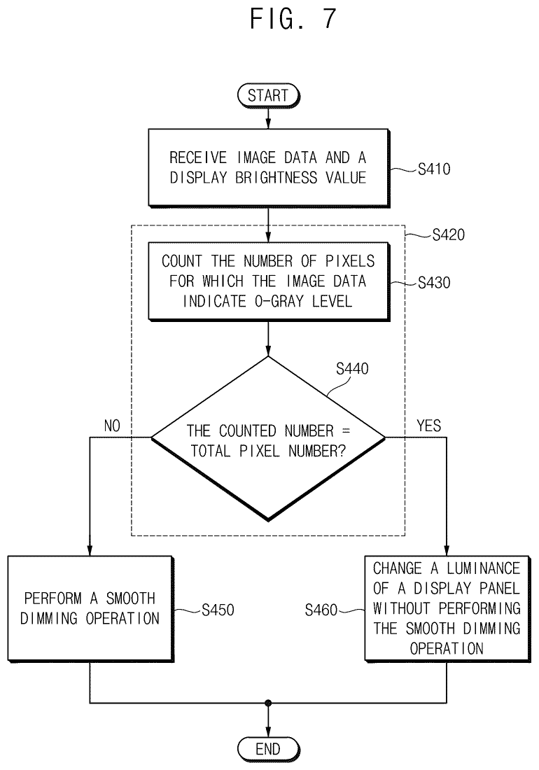

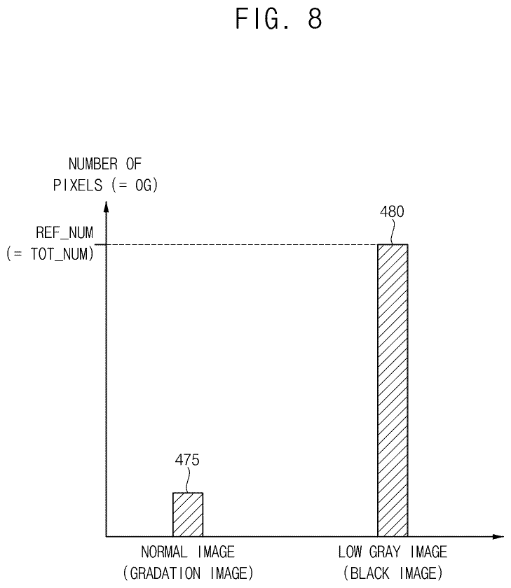

FIG. 7 is a flowchart illustrating a method of operating a display device according to embodiments, and FIG. 8 is a diagram for describing an example in which it is determined whether image data represent a low gray image.

Referring to FIGS. 1, 5 and 7, the panel driver 120 of the display device 100 may receive the input image data IDAT and the display brightness value DBV from the processor in an operation S410. The panel driver 120 may determine whether the input image data IDAT (or the output image data ODAT) represent the low gray image in an operation S420, and may selectively perform the smooth dimming operation depending on whether the input image data IDAT represent the low gray image in operations S450 and S460.

In some embodiments, the low gray image determining block 170 may count the number of the pixels PX for which the image data DAT (e.g., the input image data IDAT or the output image data ODAT) indicate the 0-gray level in an operation S430, and compare the counted number of the pixels PX with the total number of the plurality of pixels PX in an operation S440. If the counted number of the pixels PX is less than the total number of the pixels PX in the operation S440, i.e., NO, the low gray image determining block 170 may determine that the image data DAT do not represent the low gray image, and the dimming block 180 may perform the smooth dimming operation that gradually changes the luminance of the display panel 110 to the luminance corresponding to the display brightness value DBV over the plurality of frame periods in the operation S450. For example, to perform the smooth dimming operation, the dimming block 180 may control the gamma voltage generator 140 to gradually change the gamma voltages VGMA over the plurality of frame periods. In an embodiment, if the counted number of the pixels PX is equal to the total number of the plurality of pixels PX in the operation S440, i.e., YES, the low gray image determining block 170 may determine that the image data DAT represent the low gray image, and the dimming block 180 may change the luminance of the display panel 110 to the luminance corresponding to the display brightness value DBV in the frame period in which the display brightness value DBV is received without performing the smooth dimming operation in the operation S460. For example, in order not to perform the smooth dimming operation, the dimming block 180 may control the gamma voltage generator 140 to change the gamma voltages VGMA in the frame period in which the display brightness value DBV is received.

For example, as illustrated in FIG. 8, in a case where the image data DAT represent a normal image (e.g., a gradation image), the number 475 of the pixels PX for which the image data DAT indicate the 0-gray level may be less than the reference number REF_NUM that is the total number TOT_NUM of the plurality of pixels PX. In this case, the low gray image determining block 170 may determine that the image data DAT do not represent the low gray image, and the dimming block 180 may perform the smooth dimming operation. In an embodiment, in a case where the image data DAT represent the low gray image (e.g., the black image), the number 480 of the pixels PX for which the image data DAT indicate the 0-gray level may be equal to the reference number REF_NUM that is the total number TOT_NUM of the plurality of pixels. In this case, the low gray image determining block 170 may determine that the image data DAT represent the low gray image, and the dimming block 180 may not perform the smooth dimming operation. Accordingly, when the normal image is displayed after the low gray image is displayed, or when the mode of the display device 100 is switched, the undesired luminance change caused by the smooth dimming operation may be prevented from being perceived.

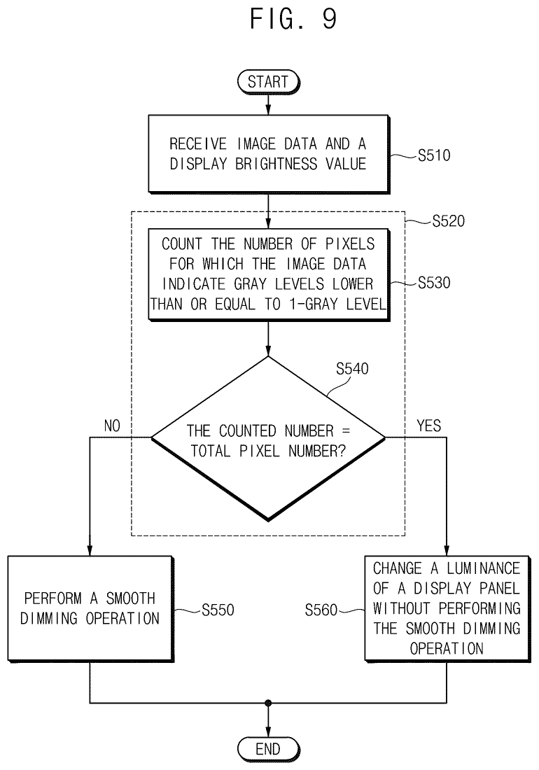

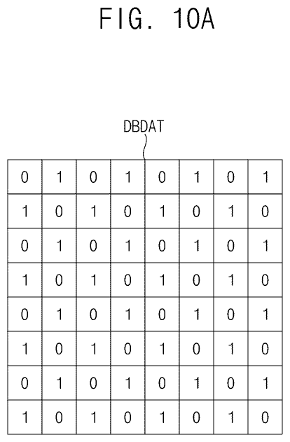

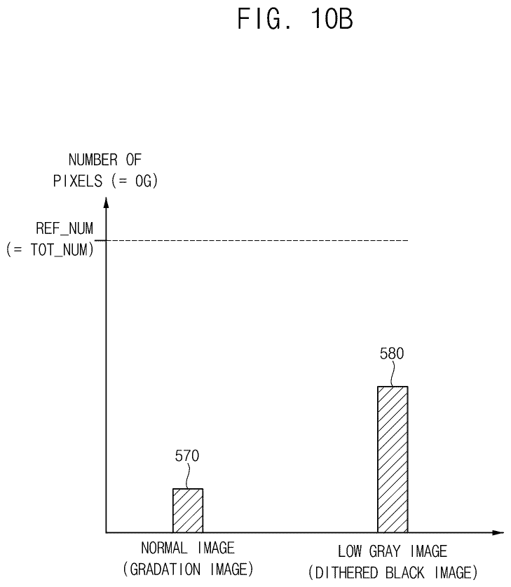

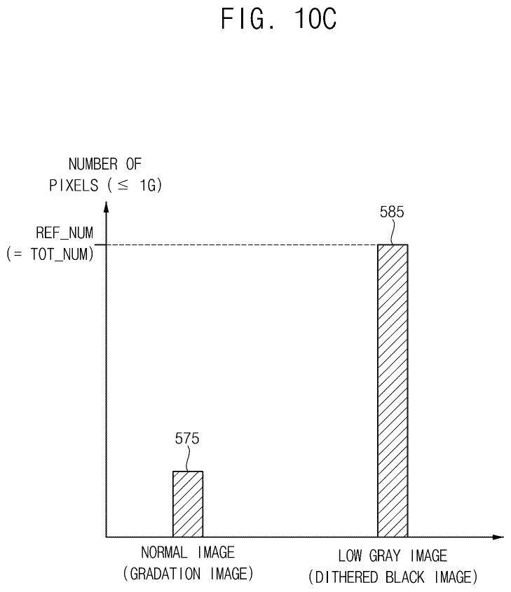

FIG. 9 is a flowchart illustrating a method of operating a display device according to embodiments, FIG. 10A is a diagram illustrating an example of dithered black image data, and FIGS. 10B and 10C are diagrams for describing examples in which it is determined whether image data represent a low gray image.

Referring to FIGS. 1, 5 and 9, the panel driver 120 of the display device 100 may receive the input image data IDAT and the display brightness value DBV from the processor in an operation S510. The panel driver 120 may determine whether the input image data IDAT (or the output image data ODAT) represent the low gray image in an operation S520, and may selectively perform the smooth dimming operation depending on whether the input image data IDAT represent the low gray image in operations S550 and S560.

In some embodiments, the low gray image determining block 170 may count the number of pixels PX for which the image data DAT (e.g., the input image data IDAT or the output image data ODAT) indicate a gray level lower than or equal to a 1-gray level in an operation S530, and may compare the counted number of the pixels PX with the total number of the plurality of pixels PX in an operation S540. If the counted number of the pixels PX is less than the total number of the pixels in the operation S540, i.e., NO, the low gray image determining block 170 may determine that the image data DAT do not represent the low gray image, and the dimming block 180 may perform the smooth dimming operation that gradually changes the luminance of the display panel 110 to the luminance corresponding to the display brightness value DBV over the plurality of frame periods in the operation S550. In an embodiment, if the counted number of the pixels PX is equal to the total number of the pixels PX in the operation S540, i.e., YES, the low gray image determining block 170 may determine that the image data DAT represent the low gray image, and the dimming block 180 may not perform the smooth dimming operation, and may change the luminance of the display panel 110 to the luminance corresponding to the display brightness value DBV in the frame period in which the display brightness value DBV is received in the operation S560.

For example, as illustrated in FIG. 10A, the processor may perform a dithering operation, and may provide dithered black image data DBDAT as the input image data IDAT to the display device 100 such that the display device 100 may display a black image (or a dithered black image). The dithered black image data DBDAT may alternately indicate the 0-gray level and the 1-gray level for the plurality of pixels PX. In a case where the reference gray level is the 0-gray level, or a case where the low gray image determining block 170 counts the number of pixels PX for which the image data DAT indicate the 0-gray level, as illustrated in FIG. 10B, not only the number 570 of pixels PX for which the image data DAT indicate the 0-gray level when the display device 100 displays the normal image (e.g., the gradation image), but also the number 580 of pixels PX for which the image data DAT indicate the 0-gray level when the display device 100 displays the low gray image (e.g., the dithered black image) may be less than the reference number REF_NUM that is the total number TOT_NUM of the plurality of pixels PX. However, in the method of operating the display device 100 according to embodiments, the reference gray level may be the 1-gray level, and the low gray image determining block 170 may count the number of pixels PX for which the image data DAT indicate gray levels lower than or equal to the 1-gray level. Thus, as illustrated in FIG. 10C, the number 575 of pixels PX for which the image data DAT indicate gray levels lower than or equal to the 1-gray level when the display device 100 displays the general image may be less than the reference number REF_NUM, but the number 585 of pixels PX for which the image data DAT indicate gray levels lower than or equal to the 1-gray level may be equal to the reference number REF_NUM that is the total number TOT_NUM of the pixels PX when the display device 100 displays the black image (or the dithered black image). In this case, the low gray image determining block 170 may determine that the image data DAT represents the low gray image, and the dimming block 180 may not perform the smooth dimming operation. Accordingly, when the normal image is displayed after the low gray image is displayed, or when the mode of the display device 100 is switched, the undesired luminance change caused by the smooth dimming operation may be prevented from being perceived.

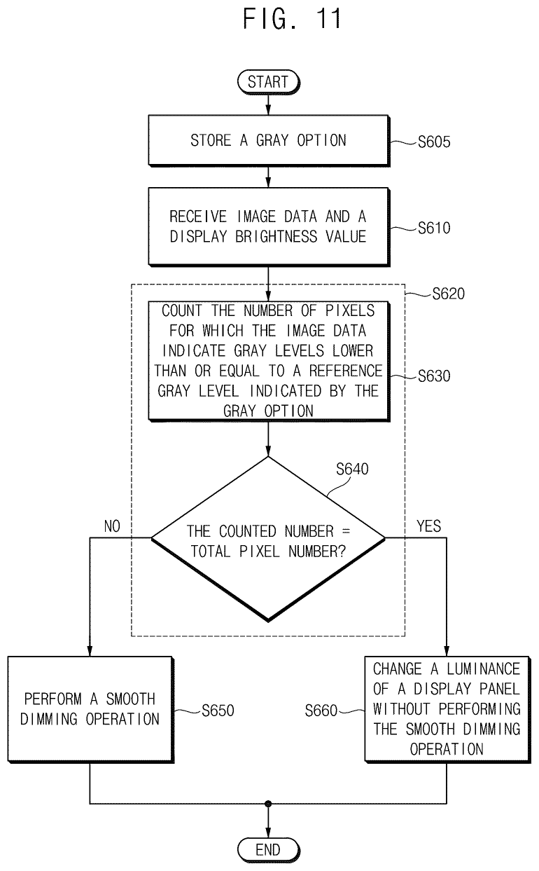

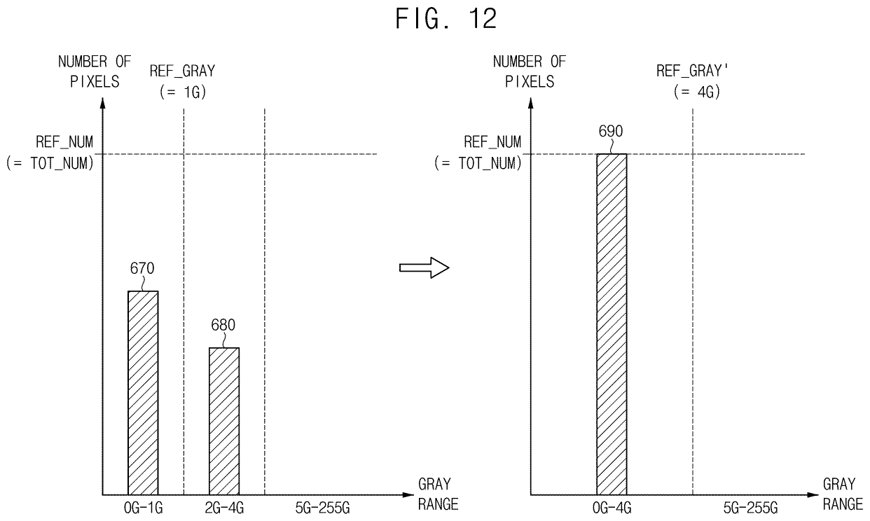

FIG. 11 is a flowchart illustrating a method of operating a display device according to embodiments, and FIG. 12 is a diagram for describing examples in which it is determined whether image data represent a low gray image.

Referring to FIGS. 1, 5 and 11, the panel driver 120 (or the controller 160) may include the option storing block 190, and the option storing block 190 may store the gray option GRAY_OP for setting the reference gray level in an operation S605. The panel driver 120 may receive the input image data IDAT and the display brightness value DBV from the processor in an operation S610. The panel driver 120 may determine whether the input image data IDAT (or the output image data ODAT) represent the low gray image in an operation S620, and may selectively perform the smooth dimming operation depending on whether the input image data IDAT represent the low gray image in operations S650 and S660.

In some embodiments, the low gray image determining block 170 may count the number of pixels PX for which the image data DAT (e.g., the input image data IDAT or the output image data ODAT) indicate gray levels lower than or equal to the reference gray level indicated by the gray option GRAY_OP in an operation S630, and may compare the counted number of the pixels PX with the total number of the plurality of pixels PX in an operation S640. If the counted number of the pixels PX is less than the total number of the pixels PX in the operation S640, i.e., NO, the low gray image determining block 170 may determine that the image data DAT do not represent the low gray image, and the dimming block 180 may perform the smooth dimming operation that gradually changes the luminance of the display panel 110 to the luminance corresponding to the display brightness value DBV over the plurality of frame periods in the operation S650. In an embodiment, if the counted number of the pixels PX is equal to the total number of the pixels PX in the operation S640, i.e., YES, the low gray image determining block 170 may determine that the image data DAT represent the low gray image, and the dimming block 180 may change the luminance of the display panel 110 to the luminance corresponding to the display brightness value DBV in the frame period in which the display brightness value DBV is received without performing the smooth dimming operation in the operation S660.

For example, as illustrated in FIG. 12, although the image data DAT represent the low gray image for which the smooth dimming operation is unnecessary, if the reference gray level REF_GRAY is the 1-gray level 1G, and the image data DAT indicate the 0-gray level to the 1-gray level 0G-1G for a first number 670 of pixels PX and a 2-gray level to a 4-gray level 2G-4G for a second number 680 of pixels PX, the low gray image determining block 170 may determine that the image data DAT do not represent the low gray image because the first number 670 of pixels PX lower than or equal to the reference gray level REF_GRAY is less than the reference number REF_NUM that is the total number TOT_NUM of the pixels PX. However, in a case where the reference gray level REF_GRAY′ is set to a 4-gray level 4G by the gray option GRAY_OP, the number 690 of pixels PX for which the image data DAT indicate gray levels lower than or equal to the reference gray level REF_GRAY′ may be equal to the reference number REF_NUM that is the total number TOT_NUM of the pixels PX. In this case, the low gray image determining block 170 may determine that the image data DAT represent the low gray image, and the dimming block 180 may not perform the smooth dimming operation. Accordingly, when the normal image is displayed after the low gray image is displayed, or when the mode of the display device 100 is switched, the undesired luminance change caused by the smooth dimming operation may be prevented from being perceived.

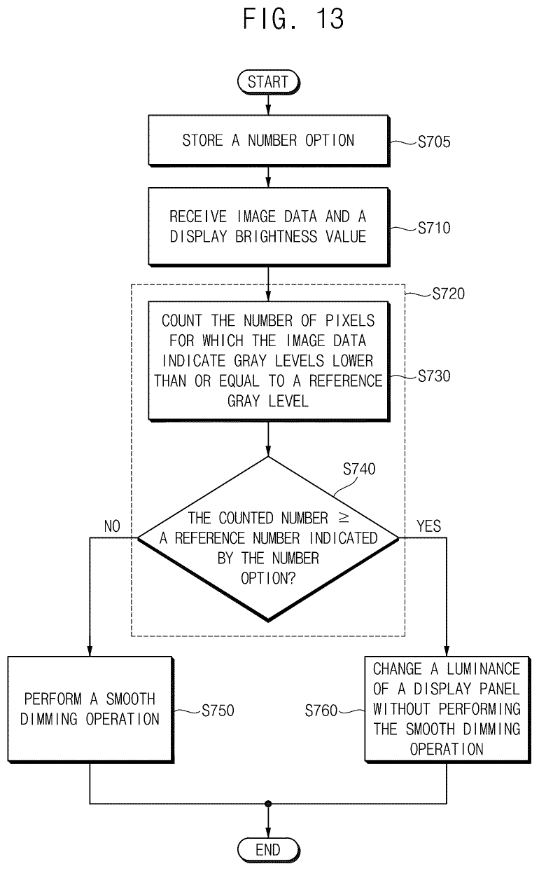

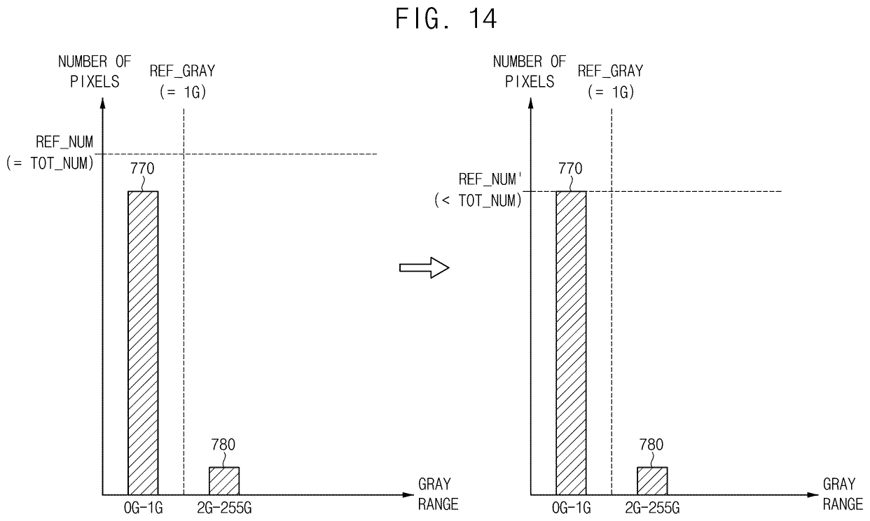

FIG. 13 is a flowchart illustrating a method of operating a display device according to embodiments, and FIG. 14 is a diagram for describing examples in which it is determined whether image data represent a low gray image.

Referring to FIGS. 1, 5 and 13, the panel driver 120 (or the controller 160) may include the option storing block 190, and the option storing block 190 may store the number option NUM_OP for setting the reference number in an operation S705. The panel driver 120 may receive the input image data IDAT and the display brightness value DBV from the processor in an operation S710. The panel driver 120 may determine whether the input image data IDAT (or the output image data ODAT) represent the low gray image in an operation S720, and may selectively perform the smooth dimming operation depending on whether the input image data IDAT represent the low gray image in operations S750 and S760.

In some embodiments, the low gray image determining block 170 may count the number of pixels PX for which the image data DAT (e.g., the input image data IDAT or the output image data ODAT) indicate gray levels lower than or equal to the reference gray level in an operation S730, and may compare the counted number of the pixels PX with the reference number indicated by the number option NUM_OP in an operation S740. If the counted number of the pixels PX is less than the reference number in the operation S740, i.e., NO, the low gray image determining block 170 may determine that the image data DAT do not represent the low gray image, and the dimming block 180 may perform the smooth dimming operation that gradually changes the luminance of the display panel 110 to the luminance corresponding to the display brightness value DBV over the plurality of frame periods in the operation S750. In an embodiment, if the counted number of the pixels PX is greater than or equal to the reference number in the operation S740, i.e., YES, the low gray image determining block 170 may determine that the image data DAT represent the low gray image, and the dimming block 180 may change the luminance of the display panel 110 to the luminance corresponding to the display brightness value DBV in the frame period in which the display brightness value DBV is received without performing the smooth dimming operation in the operation S760.

For example, as illustrated in FIG. 14, in a case where the image data DAT represent the low gray image for which the smooth dimming operation is unnecessary, but the reference gray level REF_GRAY is the 1-gray level 1G, the reference number REF_NUM is the total number TOT_NUM of the pixels PX, and the image data DAT indicate the 0-gray level to the 1-gray level 0G-1G for a first number 770 of the pixels PX and the 2-gray level to the 255-gray level 2G-255G for a second number 780 of the pixels PX, the low gray image determining block 170 may determine that the image data DAT do not represent the low gray image because the first number 770 of the pixels PX lower than or equal to the reference gray level REF_GRAY is less than the reference number REF_NUM. However, in a case where the reference number REF_NUM′ is set to be less than the total number TOT_NUM of the pixels PX by the number option NUM_OP, the first number 770 of the pixels PX for which the image data DAT indicate the gray levels lower than or equal to the reference gray level REF_GRAY may be greater than or equal to the reference number REF_NUM′ that is less than the total number TOT_NUM of the pixels PX. In this case, the low gray image determining block 170 may determine that the image data DAT represent the low gray image, and the dimming block 180 may not perform the smooth dimming operation. Accordingly, when the normal image is displayed after the low gray image is displayed, or when the mode of the display device 100 is switched, the undesired luminance change caused by the smooth dimming operation may be prevented from being perceived.

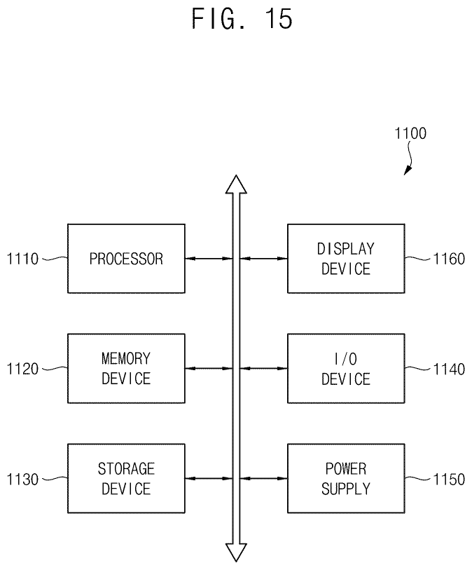

FIG. 15 is a block diagram illustrating an electronic device 1100 including a display device 1160 according to embodiments.

Referring to FIG. 15, the electronic device 1100 may include a processor 1110, a memory device 1120, a storage device 1130, an input/output (I/O) device 1140, a power supply 1150 and the display device 1160. The electronic device 1100 may further include a plurality of ports for communicating with a video card, a sound card, a memory card, a universal serial bus (“USB”) device, other electric devices, etc.

The processor 1110 may perform various computing functions or tasks. The processor 1110 may be an application processor (“AP”), a micro-processor, a central processing unit (“CPU”), etc. The processor 1110 may be coupled to other components via an address bus, a control bus, a data bus, etc. Further, in some embodiments, the processor 1110 may be further coupled to an extended bus such as a peripheral component interconnection (“PCI”) bus.

The memory device 1120 may store data for operations of the electronic device 1100. For example, the memory device 1120 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or at least one volatile memory device such as a dynamic random access memory (“DRAM”) device, a static random access memory (“SRAM”) device, a mobile dynamic random access memory (“mobile DRAM”) device, etc.

The storage device 1130 may be a solid state drive (“SSD”) device, a hard disk drive (“HDD”) device, a compact disc-read only memory (“CD-ROM”) device, etc. The I/O device 1140 may be an input device such as a keyboard, a keypad, a mouse, a touch screen, etc., and an output device such as a printer, a speaker, etc. The power supply 1150 may supply power for operations of the electronic device 1100. The display device 1160 may be coupled to other components through the buses or other communication links.

In the display device 1160, a smooth dimming operation that gradually changes a luminance of a display panel to a luminance corresponding to a display brightness value over a plurality of frame periods may be performed in a first case where image data do not represent a low gray image (e.g., a black image), and the smooth dimming operation may not be performed in a second case where the image data represent the low gray image. Accordingly, when a normal image is displayed after the low gray image is displayed, or when a mode of the display device 1160 is switched, a luminance change caused by the smooth dimming operation may be prevented from being perceived.

The inventive concepts may be applied any electronic device 1100 including the display device 1160. For example, the inventive concepts may be applied to a virtual reality (“VR”) device, an augmented reality (“AR”) device, a mixed reality (“MR”) device, an extended reality (“XR”) device, a mobile phone, a smart phone, a television (“TV”) (e.g., a digital TV, a three-dimensional (“3D”) TV, etc.), a wearable electronic device, a personal computer (“PC”) (e.g. a laptop computer, a tablet computer, etc.), a home appliance, a personal digital assistant (“PDA”), a portable multimedia player (“PMP”), a digital camera, a music player, a portable game console, a navigation device, etc.

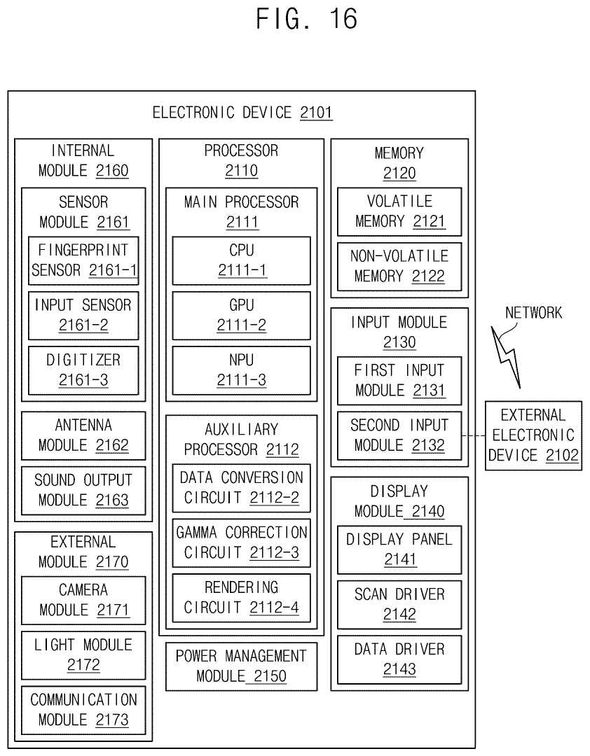

FIG. 16 is a block diagram illustrating an example of an electronic device 2101 according to embodiments.

The electronic device 2101 may output various information via a display module 2140 in an operating system. When a processor 2110 executes an application stored in a memory 2120, the display module 2140 may provide application information to a user via a display panel 2141.

The processor 2110 may obtain an external input via an input module 2130 or a sensor module 2161 and may execute an application corresponding to the external input. For example, when the user selects a camera icon displayed on the display panel 2141, the processor 2110 may obtain a user input via an input sensor 2161-2 and may activate a camera module 2171. The processor 2110 may transfer image data corresponding to an image captured by the camera module 2171 to the display module 2140. The display module 2140 may display an image corresponding to the captured image via the display panel 2141.

As another example, when personal information authentication is executed in the display module 2140, a fingerprint sensor 2161-1 may obtain input fingerprint information as input data. The processor 2110 may compare the input data obtained by the fingerprint sensor 2161-1 with authentication data stored in the memory 2120, and may execute an application according to the comparison result. The display module 2140 may display information executed according to application logic via the display panel 2141.

As still another example, when a music streaming icon displayed on the display module 2140 is selected, the processor 2110 obtains a user input via the input sensor 2161-2 and may activate a music streaming application stored in the memory 2120. When a music execution command is input in the music streaming application, the processor 2110 may activate a sound output module 2163 to provide sound information corresponding to the music execution command to the user.

In the above, an operation of the electronic device 2101 has been briefly described. Hereinafter, a configuration of the electronic device 2101 will be described in detail. Some components of the electronic device 2101 described below may be integrated and provided as one component, or one component may be provided separately as two or more components.

Referring to FIG. 16, the electronic device 2101 may communicate with an external electronic device 2102 via a network (e.g., a short-range wireless communication network or a long-range wireless communication network). In some embodiments, the electronic device 2101 may include the processor 2110, the memory 2120, the input module 2130, the display module 2140, a power management module 2150, an internal module 2160 and an external module 2170. In some embodiments, at least one of the components may be omitted from the electronic device 2101, or one or more other components may be added in the electronic device 2101. In some embodiments, some of the components (e.g., the sensor module 2161, an antenna module 2162, or the sound output module 2163) may be implemented as a single component (e.g., the display module 2140).

The processor 2110 may execute software to control at least one other component (e.g., a hardware or software component) of the electronic device 2101 coupled with the processor 2110, and may perform various data processing or computation. According to some embodiments, as at least part of the data processing or computation, the processor 2110 may store a command or data received from another component (e.g., the input module 2130, the sensor module 2161 or a communication module 2173) in a volatile memory 2121, may process the command or the data stored in the volatile memory 2121, and may store resulting data in a non-volatile memory 2122.

The processor 2110 may include a main processor 2111 and an auxiliary processor 2112. The main processor 2111 may include one or more of a central processing unit (“CPU”) 2111-1 or an application processor (“AP”). The main processor 2111 may further include any one or more of a graphics processing unit (“GPU”) 2111-2, a communication processor (“CP”), and an image signal processor (“ISP”). The main processor 2111 may further include a neural processing unit (“NPU”) 2111-3. The NPU 2111-3 may be a processor specialized in processing an artificial intelligence model, and the artificial intelligence model may be generated through machine learning. The artificial intelligence model may include a plurality of artificial neural network layers. The artificial neural network may be a deep neural network (“DNN”), a convolutional neural network (“CNN”), a recurrent neural network (“RNN”), a restricted Boltzmann machine (“RBM”), a deep belief network (“DBN”), a bidirectional recurrent deep neural network (“BRDNN”), deep Q-network or a combination of two or more thereof, but is not limited thereto. The artificial intelligence model may, additionally or alternatively, include a software structure other than a hardware structure. At least two of the above-described processing units and processors may be implemented as an integrated component (e.g., a single chip), or respective processing units and processors may be implemented as independent components (e.g., a plurality of chips).

The auxiliary processor 2112 may include a controller. The controller included in the auxiliary processor 2112 may correspond to a controller 160 illustrated in FIG. 1. The controller may include an interface conversion circuit and a timing control circuit. The controller may receive an image signal from the main processor 2111, may convert a data format of the image signal to meet interface specifications with the display module 2140, and may output image data. The controller may output various control signals required for driving the display module 2140. The controller may selectively perform a smooth dimming operation according to whether the image data represent a low gray image. Accordingly, an undesired luminance change caused by the smooth dimming operation may be prevented from being perceived.

The auxiliary processor 2112 may further include a data conversion circuit 2112-2, a gamma correction circuit 2112-3, a rendering circuit 2112-4, or the like. The data conversion circuit 2112-2 may receive image data from the controller. The data conversion circuit 2112-2 may compensate for the image data such that an image is displayed with a desired luminance according to characteristics of the electronic device 2101 or the user's setting, or may convert the image data to reduce power consumption or to eliminate an afterimage. The gamma correction circuit 2112-3 may convert image data or a gamma reference voltage so that an image displayed on the electronic device 2101 has desired gamma characteristics. The rendering circuit 2112-4 may receive image data from the controller, and may render the image data in consideration of a pixel arrangement of the display panel 2141 in the electronic device 2101. At least one of the data conversion circuit 2112-2, the gamma correction circuit 2112-3 and the rendering circuit 2112-4 may be integrated in another component (e.g., the main processor 2111 or the controller). At least one of the data conversion circuit 2112-2, the gamma correction circuit 2112-3 and the rendering circuit 2112-4 may be integrated in a data driver 2143 described below.

The memory 2120 may store various data used by at least one component (e.g., the processor 2110 or the sensor module 2161) of the electronic device 2101. The various data may include, for example, input data or output data for a command related thereto. The memory 2120 may include at least one of the volatile memory 2121 and the non-volatile memory 2122.

The input module 2130 may receive a command or data to be used by the components (e.g., the processor 2110, the sensor module 2161, or the sound output module 2163) of the electronic device 2101 from the outside of the electronic device 2101 (e.g., the user or the external electronic device 2102).

The input module 2130 may include a first input module 2131 for receiving a command or data from the user, and a second input module 2132 for receiving a command or data from the external electronic device 2102. The first input module 2131 may include a microphone, a mouse, a keyboard, a key (e.g., a button) or a pen (e.g., a passive pen or an active pen). The second input module 2132 may support a designated protocol capable of connecting the electronic device 2101 to the external electronic device 2102 by wire or wirelessly. In some embodiments, the second input module 2132 may include a high definition multimedia interface (“HDMI”), a universal serial bus (“USB”) interface, an SD card interface or an audio interface. The second input module 2132 may include a connector that may physically connect the electronic device 2101 to the external electronic device 2102. For example, the second input module 2132 may include an HDMI connector, a USB connector, an SD card connector or an audio connector (e.g., a headphone connector).

The display module 2140 may visually provide information to the user. The display module 2140 may include the display panel 2141, a scan driver 2142 and the data driver 2143. The display module 2140 may further include a window, a chassis and a bracket for protecting the display panel 2141.

The display panel 2141 may include a liquid crystal display panel, an organic light emitting display panel or an inorganic light emitting display panel, but the type of the display panel 2141 is not limited thereto. The display panel 2141 may be a rigid type display panel, or a flexible type display panel capable of being rolled or folded. The display module 2140 may further include a supporter, a bracket or a heat dissipation member that supports the display panel 2141.

The scan driver 2142 may be mounted on the display panel 2141 as a driving chip. In an embodiment, the scan driver 2142 may be integrated into the display panel 2141. For example, the scan driver 2142 may include an amorphous silicon TFT gate driver circuit (“ASG”), a low temperature polycrystalline silicon (“LTPS”) TFT gate driver circuit or an oxide semiconductor TFT gate driver circuit (“OSG”) embedded in the display panel 2141. The scan driver 2142 may receive a control signal from the controller and may output scan signals to the display panel 2141 in response to the control signal.

The display panel 2141 may further include an emission driver. The emission driver may output an emission control signal to the display panel 2141 in response to a control signal received from the controller. The emission driver may be formed separately from the scan driver 2142, or may be integrated into the scan driver 2142.

The data driver 2143 may receive a control signal from the controller, may convert image data into analog voltages (e.g., data voltages) in response to the control signal, and then may output the data voltages to the display panel 2141.

The data driver 2143 may be incorporated into other components (e.g., the controller). Further, the functions of the interface conversion circuit and the timing control circuit of the controller described above may be integrated into the data driver 2143.

The display module 2140 may further include a voltage generator circuit, or the like. The voltage generator circuit may output various voltages used to drive the display panel 2141.

The power management module 2150 may supply power to the components of the electronic device 2101. The power management module 2150 may include a battery that charges a power supply voltage. The battery may include a primary cell which is not rechargeable, a secondary cell which is rechargeable, or a fuel cell. The power management module 2150 may include a power management integrated circuit (“PMIC”). The PMIC may supply optimal power to each of the modules described above and modules described below. The power management module 2150 may include a wireless power transmission/reception member electrically connected to the battery. The wireless power transmission/reception member may include a plurality of antenna radiators in the form of coils.

The electronic device 2101 may further include the internal module 2160 and the external module 2170. The internal module 2160 may include the sensor module 2161, the antenna module 2162 and the sound output module 2163. The external module 2170 may include the camera module 2171, a light module 2172 and the communication module 2173.

The sensor module 2161 may detect an input by the user's body or an input by the pen of the first input module 2131, and may generate an electrical signal or data value corresponding to the input. The sensor module 2161 may include at least one of the fingerprint sensor 2161-1, the input sensor 2161-2 and a digitizer 2161-3.

The fingerprint sensor 2161-1 may generate a data value corresponding to the user's fingerprint. The fingerprint sensor 2161-1 may include any one of an optical type fingerprint sensor and a capacitive type fingerprint sensor.

The input sensor 2161-2 may generate a data value corresponding to coordinate information of the user's body input or the pen input. The input sensor 2161-2 may convert a capacitance change caused by the input into the data value. The input sensor 2161-2 may detect the input by the passive pen, or may transmit/receive data to/from the active pen.

The input sensor 2161-2 may measure a bio-signal, such as blood pressure, moisture or body fat. For example, when a portion of the body of the user touches a sensor layer or a sensing panel, and does not move for a certain period of time, the input sensor 2161-2 may output information desired by the user to the display module 2140 by detecting the bio-signal based on a change in electric field due to the portion of the body.

The digitizer 2161-3 may generate a data value corresponding to coordinate information of the input by the pen. The digitizer 2161-3 may convert an amount of an electromagnetic change caused by the input into the data value. The digitizer 2161-3 may detect the input by the passive pen, or may transmit/receive data to/from the active pen.

At least one of the fingerprint sensor 2161-1, the input sensor 2161-2 and the digitizer 2161-3 may be implemented as a sensor layer formed on the display panel 2141 through a continuous process. The fingerprint sensor 2161-1, the input sensor 2161-2 and the digitizer 2161-3 may be disposed above the display panel 2141, or at least one of the fingerprint sensor 2161-1, the input sensor 2161-2 and the digitizer 2161-3 may be disposed below the display panel 2141.

Two or more of the fingerprint sensor 2161-1, the input sensor 2161-2 and the digitizer 2161-3 may be integrated into one sensing panel through the same process. When integrated into one sensing panel, the sensing panel may be disposed between the display panel 2141 and a window disposed above the display panel 2141. In some embodiments, the sensing panel may be disposed on the window, but the location of the sensing panel is not limited thereto.

At least one of the fingerprint sensor 2161-1, the input sensor 2161-2 and the digitizer 2161-3 may be embedded in the display panel 2141. In other words, at least one of the fingerprint sensor 2161-1, the input sensor 2161-2 and the digitizer 2161-2 may be simultaneously formed through a process of forming elements (e.g., light emitting elements, transistors, etc.) included in the display panel 2141.

In addition, the sensor module 2161 may generate an electrical signal or a data value corresponding to an internal state or an external state of the electronic device 2101. The sensor module 2161 may further include, for example, a gesture sensor, a gyro sensor, an atmospheric pressure sensor, a magnetic sensor, an acceleration sensor, a grip sensor, a proximity sensor, a color sensor, an infrared (“IR”) sensor, a biometric sensor, a temperature sensor, a humidity sensor or an illuminance sensor.

The antenna module 2162 may include one or more antennas for transmitting or receiving a signal or power to or from the outside. In some embodiments, the communication module 2173 may transmit or receive a signal to or from the external electronic device 2102 through an antenna suitable for a communication method. An antenna pattern of the antenna module 2162 may be integrated into one component (e.g., the display panel 2141) of the display module 2140 or the input sensor 2161-2.

The sound output module 2163 may output sound signals to the outside of the electronic device 2101. The sound output module 2163 may include, for example, a speaker or a receiver. The speaker may be used for general purposes, such as playing multimedia or playing record. The receiver may be used for receiving incoming calls. In some embodiments, the receiver may be implemented as separate from, or as part of the speaker. A sound output pattern of the sound output module 2163 may be integrated into the display module 2140.

The camera module 2171 may capture a still image and a moving image. In some embodiments, the camera module 2171 may include one or more lenses, an image sensor or an image signal processor. The camera module 2171 may further include an infrared camera capable of measuring the presence or absence of the user, the user's location and the user's line of sight.

The light module 2172 may provide light. The light module 2172 may include a light emitting diode or a xenon lamp. The light module 2172 may operate in conjunction with the camera module 2171, or may operate independently of the camera module 2171.

The communication module 2173 may support establishing a wired or wireless communication channel between the electronic device 2101 and the external electronic device 2102 and performing communication via the established communication channel. The communication module 2173 may include a wireless communication module (e.g., a cellular communication module, a short-range wireless communication module or a global navigation satellite system (“GNSS”) communication module) or a wired communication module (e.g., a local area network (“LAN”) communication module or a power line communication (“PLC”) module). The communication module 2173 may communicate with the external electronic device 2102 via a short-range communication network (e.g., Bluetooth™, wireless-fidelity (“Wi-Fi”) direct, or infrared data association (“IrDA”)) or a long-range communication network (e.g., a cellular network, the Internet or a computer network (e.g., LAN or wide area network (“WAN”))). These various types of communication modules 2173 may be implemented as a single chip, or may be implemented as multi-chips separate from each other.

The input module 2130, the sensor module 2161, the camera module 2171, and the like may be used to control an operation of the display module 2140 in conjunction with the processor 2110.

The processor 2110 may output a command or data to the display module 2140, the sound output module 2163, the camera module 2171 or the light module 2172 based on input data received from the input module 2130. For example, the processor 2110 may generate image data corresponding to input data applied through a mouse or an active pen, and may output the image data to the display module 2140. In an embodiment, the processor 2110 may generate command data corresponding to the input data, and may output the command data to the camera module 2171 or the light module 2172. When no input data is received from the input module 2130 for a certain period of time, the processor 2110 may switch an operation mode of the electronic device 2101 to a low power mode or a sleep mode, thereby reducing power consumption of the electronic device 2101.

The processor 2110 may output a command or data to the display module 2140, the sound output module 2163, the camera module 2171 or the light module 2172 based on sensing data received from the sensor module 2161. For example, the processor 2110 may compare authentication data applied by the fingerprint sensor 2161-1 with authentication data stored in the memory 2120, and then may execute an application according to the comparison result. The processor 2110 may execute a command or output corresponding image data to the display module 2140 based on the sensing data sensed by the input sensor 2161-2 or the digitizer 2161-3. In a case where the sensor module 2161 includes a temperature sensor, the processor 2110 may receive temperature data from the sensor module 2161, and may further perform luminance correction on the image data based on the temperature data.

The processor 2110 may receive measurement data about the presence or absence of the user, the location of the user and the user's line of sight from the camera module 2171. The processor 2110 may further perform luminance correction on the image data based on the measurement data. For example, after the processor 2110 determines the presence or absence of the user based on the input from the camera module 2171, the data conversion circuit 2112-2 or the gamma correction circuit 2112-3 may perform the luminance correction on the image data, and the processor 2110 may provide the luminance-corrected image data to the display module 2140.

At least some of the above-described components may be coupled mutually and communicate signals (e.g., commands or data) therebetween via an inter-peripheral communication scheme (e.g., a bus, general purpose input and output (“GPIO”), serial peripheral interface (“SPI”), mobile industry processor interface (“MIPI”) or ultra-path interconnect (“UPI”)). The processor 2110 may communicate with the display module 2140 via an agreed interface. Further, any one of the above-described communication methods may be used between the processor 2110 and the display module 2140, but the communication method between the processor 2110 and the display module 2140 is not limited to the above-described communication method.

The electronic device 2101 according to various embodiments described above may be various types of devices. For example, the electronic device 2101 may include at least one of a portable communication device (e.g., a smart phone), a computer device, a portable multimedia device, a portable medical device, a camera, a wearable device and a home appliance. However, the electronic device 2101 according to embodiments is not limited to the above-described devices.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A display device comprising:
a display panel including a plurality of pixels; and
a panel driver configured to receive image data and a display brightness value, and to drive the display panel based on the image data and the display brightness value, the panel driver further configured:
to determine whether the image data represent a low gray image,
to perform a smooth dimming operation that gradually changes a luminance of the display panel to a luminance corresponding to the display brightness value over a plurality of frame periods in a first case where the image data do not represent the low gray image, and
not to perform the smooth dimming operation in a second case where the image data represent the low gray image.

2. The display device of claim 1, wherein, in the second case, the panel driver changes the luminance of the display panel to the luminance corresponding to the display brightness value in a frame period in which the display brightness value is received.

3. The display device of claim 2, wherein, in the first case, to perform the smooth dimming operation, the panel driver gradually changes gamma voltages over the plurality of frame periods, and
wherein, in the second case, the panel driver changes the gamma voltages in a frame period in which the display brightness value is received.

4. The display device of claim 1, wherein the low gray image is an image lower than or equal to a reference gray level.

5. The display device of claim 4, wherein the reference gray level has a fixed value.

6. The display device of claim 4, wherein the reference gray level is settable by a gray option.

7. The display device of claim 1, wherein the panel driver counts a number of pixels for which the image data indicate a gray level lower than or equal to a reference gray level among the plurality of pixels, compares the counted number of the pixels with a reference number, determines that the counted number of the pixels is greater than or equal to the reference number, and determines that the image data represent the low gray image.

8. The display device of claim 7, wherein the reference gray level and the reference number have fixed values.

9. The display device of claim 7, wherein the reference gray level is settable by a gray option, and
wherein the reference number is settable by a number option.

10. The display device of claim 1, wherein the panel driver includes:
a scan driver configured to provide scan signals to the plurality of pixels;
a gamma voltage generator configured to generate gamma voltages;
a data driver configured to provide data voltages to the plurality of pixels based on the gamma voltages; and
a controller configured to control the scan driver, the gamma voltage generator and the data driver, the controller including:
a low gray image determining block configured to determine whether the image data represent the low gray image; and
a dimming block configured to control the gamma voltage generator to adjust the gamma voltages according to the display brightness value, and to selectively perform the smooth dimming operation according to whether the image data represent the low gray image.

11. The display device of claim 10, wherein the low gray image determining block counts a number of pixels for which the image data indicate a gray level lower than or equal to a reference gray level among the plurality of pixels, compares the counted number of the pixels with a reference number, determines that the counted number of the pixels is greater than or equal to the reference number, and determines that the image data represent the low gray image.

12. The display device of claim 11, wherein the reference gray level is a 0-gray level or a 1-gray level, and
wherein the reference number is a total number of the plurality of pixels.

13. The display device of claim 10, wherein the controller further includes:
an option storing block configured to store a gray option and a number option, and
wherein the low gray image determining block counts a number of pixels for which the image data indicate a gray level lower than or equal to a reference gray level indicated by the gray option among the plurality of pixels, compares the counted number of the pixels with a reference number indicated by the number option, determines that the counted number of the pixels is greater than or equal to the reference number, and determines that the image data represent the low gray image.

14. The display device of claim 10, wherein, in the first case where the low gray image determining block determines that the image data do not represent the low gray image, the dimming block controls the gamma voltage generator to gradually change the gamma voltages over the plurality of frame periods, and
wherein, in the second case where the low gray image determining block determines that the image data represent the low gray image, the dimming block controls the gamma voltage generator to change the gamma voltages in a frame period in which the display brightness value is received.

15. A method of operating a display device, the method comprising:
receiving image data and a display brightness value;
determining whether the image data represent a low gray image;
performing a smooth dimming operation that gradually changes a luminance of the display panel to a luminance corresponding to the display brightness value over a plurality of frame periods in a first case where the image data do not represent the low gray image; and
changing the luminance of the display panel to the luminance corresponding to the display brightness value without performing the smooth dimming operation in a second case where the image data represent the low gray image.

16. The method of claim 15, wherein performing the smooth dimming operation includes:
gradually changing gamma voltages over the plurality of frame periods.

17. The method of claim 15, wherein determining whether the image data represent the low gray image includes:
counting a number of pixels for which the image data indicate a gray level lower than or equal to a reference gray level among the plurality of pixels;
comparing the counted number of the pixels with a reference number;
determining that the counted number of the pixels is greater than or equal to the reference number; and
determining that the image data represent the low gray image.

18. The method of claim 17, wherein the reference gray level and the reference number have fixed values.

19. The method of claim 17, wherein the reference gray level is settable by a gray option, and
wherein the reference number is settable by a number option.

20. An electronic device comprising:
a processor configured to provide image data and a display brightness value;
a display panel including a plurality of pixels; and
a panel driver configured to receive the image data and the display brightness value, and to drive the display panel based on the image data and the display brightness value, the panel driver further configured:
to determine whether the image data represent a low gray image,
to perform a smooth dimming operation that gradually changes a luminance of the display panel to a luminance corresponding to the display brightness value over a plurality of frame periods in a first case where the image data do not represent the low gray image, and
not to perform the smooth dimming operation in a second case where the image data represent the low gray image.
